(19) United States
(12) Patent Application Publication
(10) Pub. No.: US 2008/0151786 A1
(43) Pub. Date: Jun. 26, 2008

(54) METHOD AND APPARATUS FOR HYBRID AUDIO-VISUAL COMMUNICATION

(75) Inventors: Renxiang Li, Lake Zurich, IL (US); Carlo M. Danielsen, Lake Zurich, IL (US); Faisal Ishtiaq, Chicago, IL (US); Jay J. Williams, Skokie, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/614,560

(22) Filed: Dec. 21, 2006

(51) Int. Cl. H04L 5/14

(52) U.S. Cl. 370/276

(57) ABSTRACT

A method and apparatus for providing communication between a sending terminal and one or more receiving terminals in a communication network. The media content of a signal transmitted by the sending terminal is detected and one or more of a voice stream, an avatar control parameter stream and a video stream are generated from the media content. At least one of the voice stream, the avatar control parameter stream and the video stream are selected as an output to be transmitted to the receiving terminal. The selection may be based on user preference, channel capacity, terminal capabilities or the load status of a network server performing the selection. The network server may be operable to generate synthetic video from the voice input, a natural video input and/or incoming avatar control parameters.

### FIELD OF THE INVENTION

The present invention relates generally to telecommunication and in particular to hybrid audio-visual communication.

### BACKGROUND

Visual communication over traditionally voice centric communication systems, such as Push-To-Talk (PTT) radio systems and cellular telephone systems, is highly desirable because facial expressions and head/body gestures play a very important role in face-to-face human communications. Video communication is an example of natural visual communication, whereas avatar based communication is an example of synthetic visual communication. In the later case, an avatar representing a user is animated at the receiving terminal. The term avatar generally refers to a model that can be animated to generate a sequence of synthetic images.

Push-to-talk (PTT) is a half-duplex communication control scheme that is very cost effective for group communications. It is still popular after several decades of deployment. Visual communication over traditionally voice centric PTT is highly desirable because facial expressions and head/body gestures play a very important role in face-to-face human communication. In another words, visual communications over PTT makes communication between individuals more effective. Video communication is just one type of visual communications; avatar based communication is another. In the later case, an avatar representing a user is animated at the receiving terminals. The sender controls the avatar using facial animation parameters (FAPs) and body animation parameters (BAPs). It is widely recognized that users can express themselves better by choosing the appropriate avatars and exaggerating/distorting emotions.

Solutions already exist for push-to-talk, push-to-view (images), and push-to-video. In the case of push-to-video, the sender's video is transmitted over, in real-time, to all receiving terminals. However, these solutions built on top of PTT do not solve the more general issue of allowing heterogeneous PTT phones seamlessly operating together for visual communications, with minimum user setup and maximum flexibility for self-expression, including the use of avatars.

The support of natural and/or synthetic visual communications is problematic because user equipment has a variety of multimedia capabilities. PTT phones generally fall into the following categories that are capable of:
1. both video encoding/decoding and avatar rendering
2. avatar rendering and video decoding but not video encoding
3. video decoding only
4. voice only

One problem is how to animate an avatar on a user terminal that can decode video but cannot render synthetic images. Another problem is how to allow a user to select between video and avatar images if the user terminal supports both capabilities. Another problem is how to adapt to fluctuation of channel capacity so that when QoS degrades, video can be switched to avatar communications (which usually requires much less channel bandwidth than video). A still further problem is how, when and where to perform necessary transcoding in order to bridge terminals having different capabilities. For example, how is the voice call from a voice-only sending terminal to be visualized on receiving terminal that is video or avatar capable?

Techniques are known for viewing images (push-to-view) or video (push-to-video) over push-to-talk systems. In addition, a receiving terminal may select an avatar to be displayed using the caller's ID. Avatar assisted affecting voice call; and the use of avatars as an alternative for low-bandwidth video communication are also known.

An apparatus has been disclosed for offering a service for distinguishing callers, so that when a mobile terminal has an incoming call, information (avatar, ring tone, etc) related to the caller is searched from a database, and results are transmitted to the recipient's mobile terminal. The user can request the database to check the list of available images from which they can choose from.

A telephone number management service and avatar providing apparatus has also been disclosed. In this approach, a user can register with the apparatus and create his, or her, own avatar. When a mobile communication device has an incoming call, it checks with the management service by caller's ID. If an avatar exists in the database for the caller, the avatar is transmitted and displayed to the mobile terminal.

Methods have also been disclosed for associating an avatar with a caller's ID (CID) and for efficient animation of realistic, speaking 3D characters in real time. This is achieved by defining a behavior database. Specified cases of real time avatar animation driven by text source, audio source or user input through User Interface (UI).

Use of an avatar that is transmitted along with audio and is initiated through a single button press has been disclosed.

A method has been disclosed for assisting voice conversations through affective messaging. When a telephone call is established, an avatar of the user's choice is downloaded to recipient's device for display. During conversation, the avatar is animated and controlled by affective messages received from the owner. These affective messages are generated by participants using various implicit user inputs, such as, gestures, tones of voices, etc. Since these messages typically occur in a low rate, they can be sent using a short message service (SMS). The affective messages transmitted between parties can either be encoded into special code for privacy or be sent via plain text for simplicity.

It is known that extreme video compression may be achieved by utilizing an avatar reference. By utilizing a convenient set of avatars to represent the basic categories of a human's appearance, each person whose image is being transmitted is represented by the one avatar of the set of avatars that is closest to the person involved.

Avatars may be used as a lower-bandwidth alternative to video conferencing. An animation of a face can be controlled through speech processing so that the mouth moves in synchrony with the speech. Keypad buttons of a phone may be used to express emotional state during a call. In an “avatar” telephone call, each call participant is allowed to press the buttons to indicate their desired facial expression.

Avatar images may be controlled remotely using mobile phone.

In summary, the prior techniques address how to make multimedia over PTT more efficient at a network level, how to adapt video transmission to maintain quality of service or adapt to terminal capabilities, and how to drive avatar animation.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an exemplary communication system consistent with some embodiments of the invention.

FIG. 2 is an exemplary receiving terminal consistent with some embodiments of the invention.

FIG's 3-6 show an exemplary server consistent with some embodiments of the invention.

FIG. 7 is a flow chart of a method for providing hybrid audio visual communication consistent with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to hybrid audio-visual communication. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element that is preceded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of hybrid audio-visual communication described herein. The non-processor circuits may include, but are not limited to, a radio receiver, a radio transmitter, signal drivers, clock circuits, power source circuits, and user input devices. As such, these functions may be interpreted as a method to perform hybrid audio-visual communication. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

One embodiment of the invention relates to a method for providing communication between a sending terminal and a receiving terminal in a communication network. Communication is provided by detecting the media content of a signal transmitted by the sending terminal, generating, from the media content, a voice stream, an avatar control parameter stream and a video stream, selecting, as output, at least one of the voice stream, the avatar control parameter stream and the video stream; and transmitting the selected output to the receiving terminal.

The method may be implemented in a network server that includes a viseme detector operable to receive a voice component of an incoming communication stream from the sending terminal and generate first avatar control parameters therefrom, a video tracker operable to receive a video component of the incoming communication stream generate second avatar control parameters therefrom, an avatar rendering engine, operable to render avatar images dependent upon at least one of the first avatar control parameters, second avatar control parameters and avatar control parameters in the incoming communication stream, a video encoder, operable to encode the rendered avatar images to produce a synthetic video stream and an adaptation decision unit. The adaptation decision unit receives as input one or more of: the voice component of the incoming communication stream, avatar control parameters in the incoming communication stream or generated from elements at the server, a natural video component of the incoming communication stream, and the synthetic video stream, and is operable to select at least one of the inputs as an output to be transmitted to the receiving terminal.

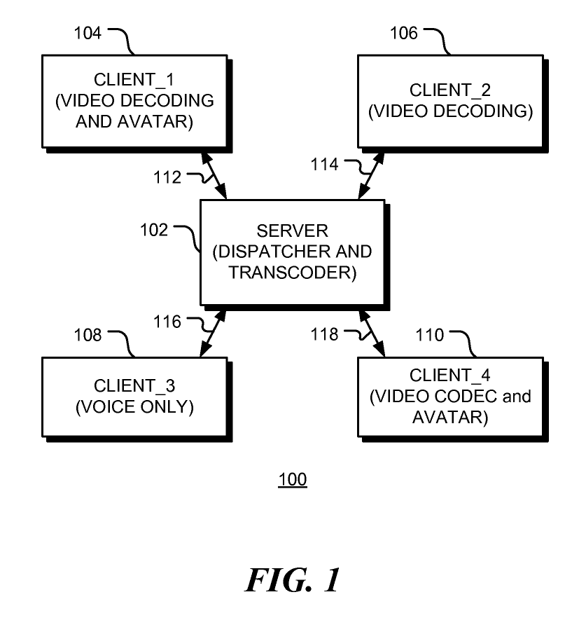

FIG. 1 is an exemplary communication system in accordance with some embodiments of the invention. The communication system 100 includes a server 102 and four clients (104, 106, 108 and 1 10). The server 102 may operate a dispatcher and transcoder to facilitate communication between the clients. The clients are user terminals (such as push-to-talk radios, or radio telephones, for example). In the simplified exemplary in FIG. 1, the user terminals have different capabilities for dealing with audio/visual information. For example, client_1 104 has both video decoding and avatar rendering capability, client_2 106 has video decoding capability, client_3 has no visual processing capability (voice only) and client_4 has video encoding and decoding capability. All clients have voice processing capability and may also have text processing capability.

TABLE 1

| TERMINAL | |
|---|---|
| TYPE | CAPABILITY |
| Voice only | Can only send and receive voice. Very primitive or |
| | no display. Most phones have the capability sending |
| | text message |
| Video playback | Multimedia phone that can play back standard |
| only | (e.g. MPEG-4, H.264) or proprietary video streams but |
| | lack capability of real-time encoding |
| Avatar only | Capable of transmitting voice and avatar control |
| | parameters, and animate avatar based on receiving |
| | animation parameters |
| Video codec + | Most advanced terminal that can do both |
| Avatar | real-time video encoding and 3D avatar rendering. |

In addition to the differing capabilities of the user terminal, the communication channels (112, 114, 116 and 118 in FIG. 1) may have different (and time varying) characteristics that affect the rate at which information can be transmitted over the channel. Video communication requires that a high bandwidth channel is available. It is known that the use of avatars (synthetic images) requires less bandwidth than video using natural images captured by a camera.

To enable effective audio/visual communication between the user terminals, the server must adapt to both channel variations and variations in user equipment.

The present invention relates to hybrid natural and synthetic visual communication over communication networks. The communication network may be, for example, a push-to-talk (PPT) infrastructure that uses PTT telephones that have various multimedia processing capabilities. In one embodiment, communication is facilitated through media adaptation and transcoding decisions at a server within the network. The adaptation is dependent upon network terminal capability, user preference and network QoS. Other factors may be taken into consideration. The invention has application to various communication networks including, but not limited to, cellular wireless networks and PTT infrastructure.

In one embodiment, the receiving terminal adapts to the type of the transmitted media. In this embodiment, the receiving terminal checks a header of the incoming system level communication stream to determine whether it is an avatar animation stream or a video stream, and delegates the stream to either an avatar render engine or a video decoding engine for presentation.

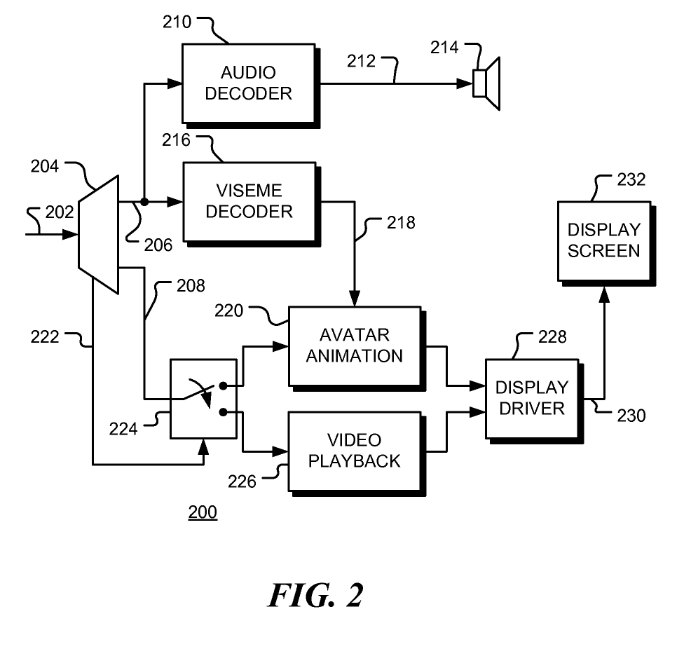

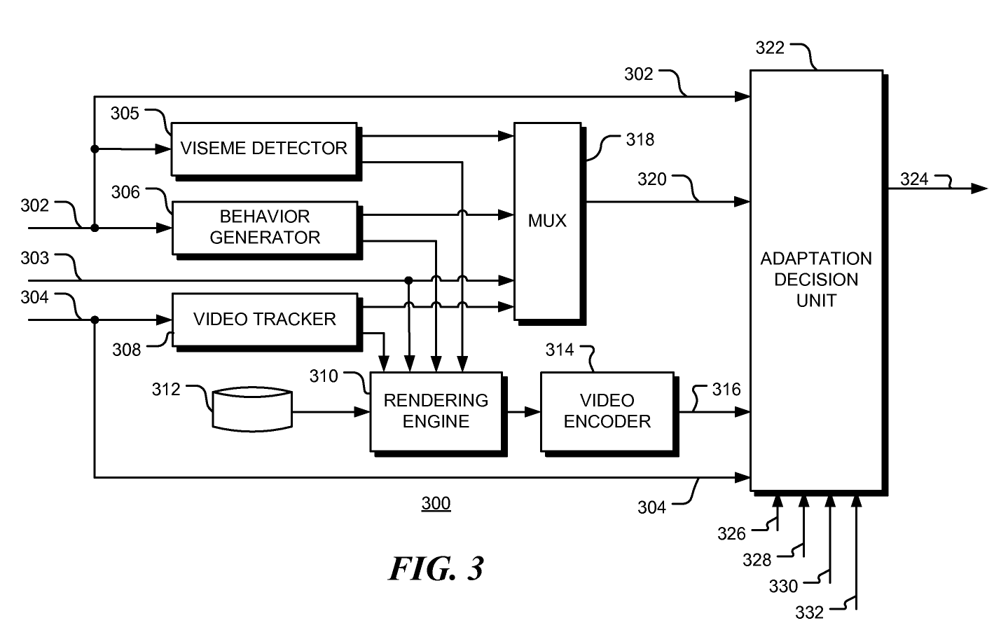

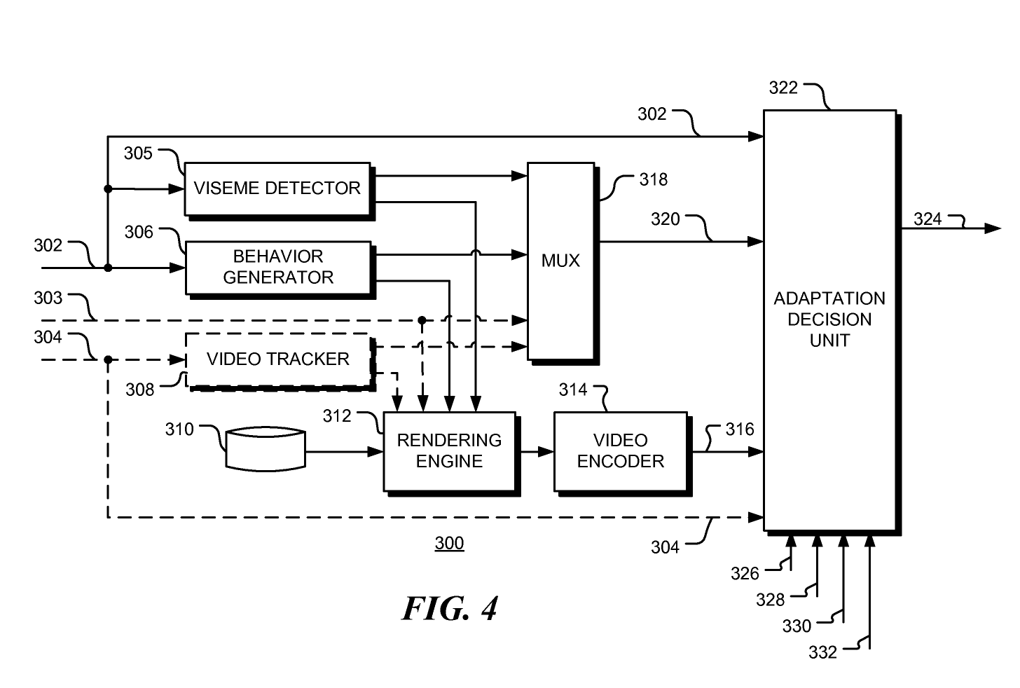

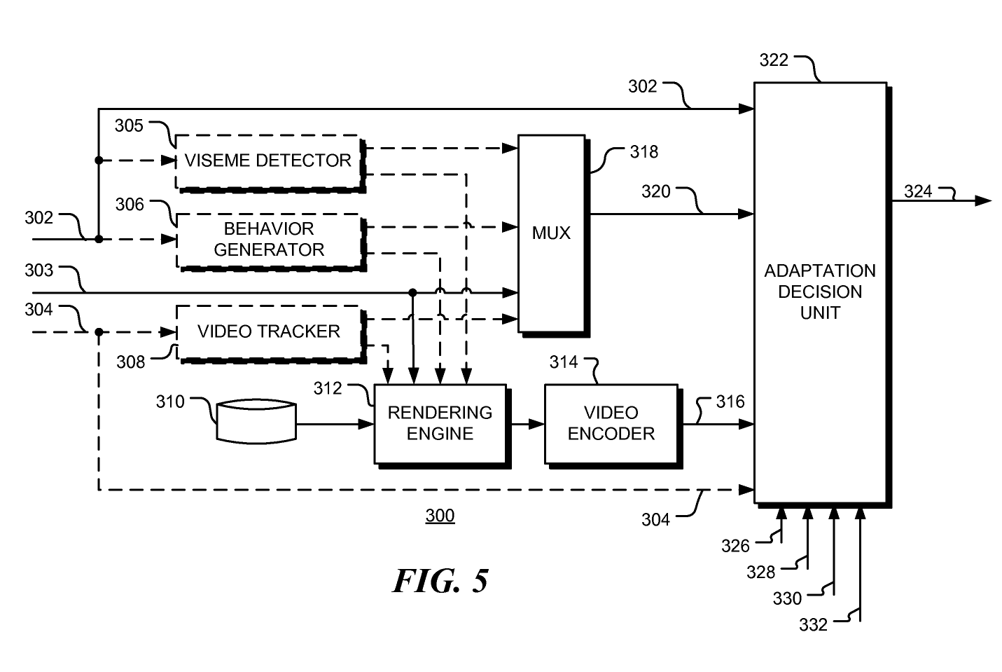

FIG. 2 is block diagram of a user receiving terminal consistent with some embodiments of the invention. The user receiving terminal adapts to the type of the transmitted media. An incoming system level communication stream 202 is passed to a de-multiplexer 204 which separates the audio content 206 of the signal from the visual content 208. This may be done, for example, by checking a header of the communication stream. The audio content is passed to an audio decoder 210 which generates an audio (usually voice) signal 212 to drive a loudspeaker 214.

The audio communication signal may be used to drive an avatar on the terminal. For example, if a sending terminal is only capable of voice transmission, the receiving terminal can generate an animated avatar with lip movement synchronized to the audio signal. The avatar may be generated at all receiving terminals that have the capability of avatar rendering or video playback. To generate the avatar synthetic images from the audio content, the audio content is passed to a viseme decoder 216. A viseme is a generic facial image, or a sequence of images, that can be used to describe a particular sound. A viseme is the visual equivalent of a phoneme or unit of sound in spoken language. The viseme decoder 216 recognizes phonemes or other speech components in the audio signal and generates a signal 218 representative of a corresponding viseme. The viseme signal 218 is passed to an avatar animation unit 220 that is operable to generate avatars that display the corresponding viseme. In addition to enhancing communication for a hearing user, visemes allow hearing-impaired users to view sounds visually and facilitate “lip-reading” the entire human face.

The de-multiplexer 204 is operable to detect whether the visual content of the incoming communication stream 202 relates to a synthetic image (an avatar) or a natural image and generate a switch signal 222 that is used to control switch 224. The switch 224 direct the visual content 208 to the either the avatar rendering unit 220 or a video playback unit 226. The video playback unit 226 is operable to decode the video content of the signal.

A display driver 228 receives either the generated avatar or the decoded video and generates a signal 230 to drive a display 232.

In a further embodiment, the media type is adapted based upon user preference of media type for visual communication. For video enabled terminals, a user can choose either video communication or avatar communication; the selection can be changed during the communication.

The receiving terminal may also include a means for disabling one or more of the processing units (that is, at least one of the viseme detector, the video tracker, the avatar rendering engine, the video encoder, and the adaptation decision unit). The choice of which processing unit to disable may be dependent upon the input media modality or user selection, or a combination thereof.

In a still further embodiment, the network is adapted for visual communication. In this embodiment, the network is operable to switch between video communication and avatar usage.

Table 2, below, summarizes the transcoding tasks that enable the server to bridge between two different types of sending and receiving terminals.

TABLE 2

| | | VIDEO | | |
|---|---|---|---|---|
| TERMINAL | VOICE | PLAYBACK | | |
| TYPES | ONLY | ONLY | AVATAR ONLY | VIDEO CODEC + AVATAR |
| Voice only | Relay | Avatar rendering + video | Avatar animation | Avatar |
| | | transcoding | parameters by | animation |
| | | | voice | parameters by |
| | | | | voice |
| Text only | Transmit | Avatar rendering + video | Avatar rendering + TTS | Avatar |
| | text | transcoding | audio | rendering + TTS |
| | | | | audio |
| Video | Transmit | Avatar rendering + video | Avatar animation | Avatar |
| playback | voice only | transcoding | parameters by | animation |
| only | | | voice | parameters by |
| | | | | voice |
| Avatar only | Transmit | Avatar rendering + video | Relay animation | Relay animation |
| | voice only | transcoding | parameters | parameters |
| Video codec + avatar | Transmit | If select video, | If video, track | Relay whatever |
| | voice only | transmit; if select | video for avatar | is coming in |
| | | avatar, avatar | animation | |
| | | rendering + video | control; If avatar, | |
| | | transcoding | relay avatar | |
| | | | animation control. | |

FIG. 3 is a block diagram of an exemplary network server, consistent with some embodiments of the invention, which is operable to switch between video communication and avatar usage. The server 300 receives, as inputs, an audio (voice) signal 302, an avatar control parameter stream 303 and a video stream 304. The audio signal 302 is fed to a viseme detector 305 that is operable to recognize phonemes (or other features) in the voice signal and generate equivalent visemes. The audio signal 302 is also fed to a behavior generator 306. The behavior generator 306 may, for example, detect emotions (such as anger) exhibited in a speech signal and generate avatar control parameters to cause a corresponding behavior (such as facial expression or body language) in an avatar. The video stream 304 is fed to a video tracker 308 that is operable, for example, to detect facial expressions or gestures in the video images and encode them.

The outputs of the viseme detector 305, the behavior generator 306 and the video tracker 308, and the avatar control parameter stream 303 are used to control an avatar rendering engine 310. The avatar rendering engine 310 accesses a database 312 of avatar images and renders animated avatars dependent upon the incoming avatar control stream or features identified in the incoming voice and/or images. The avatars are passed to a video encoder 314, which generates an avatar video stream 316 of synthetic images. The animation parameter can be encoded in a number of ways. One way is to pack the animation parameter into the video streams; the other way is to use standardized system streams, such as the MPEG-4 system framework.

The avatar parameters output from the viseme detector 305, the behavior generator 306, and video tracker, together with the received avatar control parameter stream 303 may be passed to a multiplexer 318 and multiplexed into a single avatar parameter stream 320. This may be a stream of facial animation parameters (FAPs) and/or body animation parameters (BAPs) that describe how to render an avatar.

An adaptation decision unit 322 receives the voice input 302, the avatar parameter stream 320, the avatar video stream 316, and the natural video stream 304 and selects which modalities (voice, video, avatar, etc) are to be included in the output 324. The decision as to the type of modality output from the server can be based upon a number of criteria. This can be done using a rule based approach, a heuristic approach, or a graph based decision mechanism.

The selection may be dependent upon a quality of service (QoS) measure 326. For example, if the communication bandwidth is insufficient to support good video quality, a symbol may be shown at sender's terminal to suggest using avatar. Alternatively, the server can automatically use video-to-avatar transcoding in order to meet a QoS requirement.

Further, the selection may be dependent upon a user preference 328, a server load status 330 and/or a terminal capability 332.

The selection may be used to control the other components of the server, disabling components that are not required to produce the selected output.

FIG. 4 shows operation of the server for transcoding and dispatching processes for input from a sending terminal that has voice capability but no video encoding or avatar parameter generation capability. This diagram also applies to sending terminals where the only effective output is voice (this selection may be made by the sender). Unused elements are indicated by broken lines. The voice signal is passed direct to the adaptation unit 322, to provide a voice output, and also to the viseme detector 305 and behavior detector 306 to produce a avatar control parameter streams that are multiplexed in multiplexer 318. The avatar control parameter streams are also passed to the rendering engine 312, which renders images and enables video encoder 314 to generate a video stream 316. Thus, the adaptation decision unit 322 receives a voice signal 302, an avatar control parameter stream 320 and a synthetic video stream 316 and may select between these modalities.

FIG. 5 shows operation of a server for transcoding and dispatching processes for input from sending terminal that has avatar and voice capabilities, but no video encoding capability. In this case the effective input will be a voice signal 302 and animation parameters 303. This diagram also covers the case where a terminal is capable of both video encoding and avatar control, and user prefers avatar control. The voice signal is passed direct to the adaptation decision unit 322, to provide a voice output. The animation parameters (avatar control parameters) 303 are passed through multiplexer 318 to the adaptation decision unit 322. In addition, the animation parameters are passed to the rendering engine 312, which renders images and enables video encoder 314 to generate a video stream 316. Thus, the adaptation decision unit 322 receives a voice signal 302, an avatar control parameter stream 320 and a synthetic video stream 316 and may select between these modalities.

FIG. 6 shows operation of server transcoding and dispatching processes for input from terminal capable of video encoding. Notice that for video encoding capable terminals, the video could be either the original natural video, or transcoded avatar video.

The incoming video stream 304 and the voice signal 302 are passed direct to the adaptation decision unit 322. The incoming video stream 304 is also passed to video tracker 308 that identified features such as facial expressions or body gestures in the video images. The features are encoded and passed to the rendering engine 312, which renders images and enables video encoder 314 to generate a video stream 316. Thus, the adaptation decision unit 322 receives a voice signal 302, an avatar control parameter stream 320, a synthetic video stream 316 and the incoming video stream 304 and may select between these modalities.

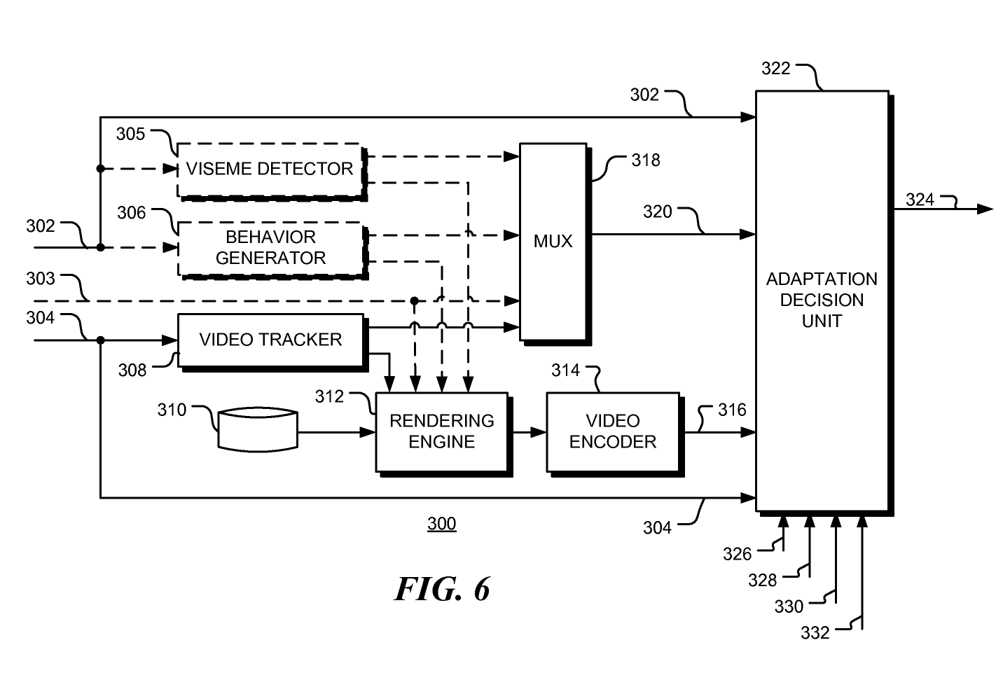

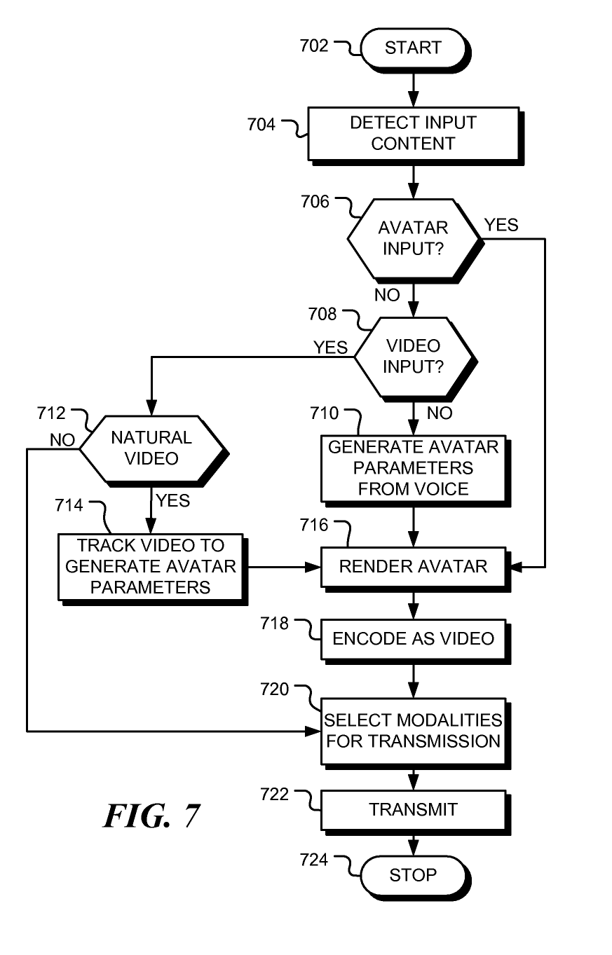

FIG. 7 is flow chart of a exemplary method for providing hybrid audio/visual communication. Referring to FIG. 7, following start block 702, a server of a communication network detects the type of content of an incoming data stream at block 704. The incoming data stream may contain any combination of audio, avatar and video inputs. The video content may be synthetic or natural. At decision block 706, the server determines if avatar content (in the form of avatar control parameters for example) is present in the incoming data stream. If no avatar content is present, as depicted by the negative branch from decision block 706, the server generates avatar parameters. At block 708 the server determines if video content (natural or synthetic) is present in the incoming data stream. If no video input is present, as depicted by the negative branch from decision block 708, the avatar parameters are generated from the voice input at block 710. If video content is present, as depicted by the positive branch from decision block 708, and the incoming data stream contains natural video input, as depicted by the positive from decision block 712, the video is tracked at block 714 to generate the avatar parameters, and an avatar is rendered from the avatar parameters at block 716. The rendered images are encoded as a video stream at block 718. If the incoming data stream contains synthetic video input, as depicted by the negative branch from decision block 712, flow continues directly to block 720. At block 720, all possible communication modalities (voice, avatar parameters, and video) have been generated and one or more of the modalities is selected for transmission. At block 722, the selected modalities are transmitted to the receiving terminal. The selection may be based upon user receiving terminal's capabilities, channel properties, user preference, and/or server load status, for example. For example, video tracking, avatar rendering and video encoding are computationally expensive, and the server may opt to avoid this step if computation resources are limited. The process terminates at bock 724.

The methods and apparatus described above, with reference to certain embodiments, enable a communication system to adapt automatically to different terminal types, media types, network conditions and user preference. This automatic adaptation minimizes user setup requirements and still provides flexibility for user to choose between natural or synthetic media type. In particular the approach enables flexible choice for the user's self-expression.

When an avatar is used, depending on the capability of the sending terminal, the user may select whether emotions, facial expressions and/or body animations are used.

The approach enables visual communication over a voice channel, without increasing the bandwidth requirement for voice communication, for legacy PTT phones or other user equipment with limited capability.

A mechanism for exchanging terminal capability at the server is provided, so that different actions can be taken according to inbound terminal type and outbound terminal type. For example, for legacy PTT phones that do not support metadata exchange, its type can be inferred from other signaling or network configurations.

Terminal capability exchange may be used, allowing the server to know whether a terminal has the capability for video, avatar, or both, or none (voice only).

In one embodiment, a user only need to select his/her own avatar, and push another button before talking to select video or avatar.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for providing communication between a sending terminal and at least one receiving terminal in a communication network, the method comprising:
detecting the media content of a signal transmitted by the sending terminal;
generating, from the media content, a voice stream, an avatar control parameter stream and a video stream;
selecting, as output, at least one of the voice stream, the avatar control parameter stream and the video stream; and
transmitting the selected output to the at least one receiving terminal.

2. A method in accordance with claim 1, wherein the media content comprises a voice stream and wherein generating an avatar control parameter stream from the media content comprises detecting features in the voice stream that correspond to visemes and generating avatar control parameters representative of the visemes.

3. A method in accordance with claim 2, wherein generating a video stream from the media content comprises:
rendering images using the avatar control parameters; and
encoding the rendered images as the video stream.

4. A method in accordance with claim 1, wherein the media content comprises a video stream and wherein generating an avatar control parameter stream from the media content comprises:
detecting facial expressions in video images contained in the video stream; and
encoding the facial expressions as avatar control parameters.

5. A method in accordance with claim 1, wherein the media content comprises a video stream and wherein generating an avatar control parameter stream from the media content comprises:
detecting gestures in video images of the video stream; and
encoding the gestures as avatar control parameters.

6. A method in accordance with claim 1, wherein the media content comprises a natural video stream, the method further comprising
detecting facial expressions in video images of the natural video stream; and
encoding the facial expressions as avatar control parameters;
rendering images using the avatar control parameters;
encoding the rendered images as a synthetic video stream; and
selecting, as output, at least of the voice stream, the avatar control parameter stream, the natural video stream and the synthetic video stream.

7. A method in accordance with claim 1, wherein the media content comprises a natural video stream, the method further comprising
detecting gestures in video images of the natural video stream; and
encoding the gestures as avatar control parameters;
rendering images using the avatar control parameters;
encoding the rendered images as a synthetic video stream; and
selecting, as output, at least of the voice stream, the avatar control parameter stream, the natural video stream and the synthetic video stream.

8. A method in accordance with claim 1, wherein the media content comprises an avatar parameter stream, and wherein generating a video stream from the media content comprises:
rendering images using the avatar control parameter stream; and
encoding the rendered images as a synthetic video stream.

9. A method in accordance with claim 1, wherein selecting, as output, at least one of the voice stream, the avatar control parameter stream and the video stream is dependent upon a preference of the user of the sending terminal.

10. A method in accordance with claim 1, wherein selecting, as output, at least one of the voice stream, the avatar control parameter stream and the video stream is dependent upon a preference of a user of the at least one receiving terminal.

11. A method in accordance with claim 1, wherein selecting, as output, at least one of the voice stream, the avatar control parameter stream and the video stream is dependent upon capabilities of the at least one receiving terminal.

12. A method in accordance with claim 1, wherein the capabilities of the at least one receiving terminal are determined by a data exchange between the at least one receiving terminal and a network server performing the method.

13. A method in accordance with claim 1, wherein selecting, as output, at least one of the voice stream, the avatar control parameter stream and the video stream is dependent upon a load status of a network server performing the method.

14. A method in accordance with claim 1, wherein selecting, as output, at least one of the voice stream, the avatar control parameter stream and the video stream is dependent upon the available capacity of a communication channel between the at least one receiving terminal and a network server performing the method.

15. A system for providing communication between a sending terminal and at least one receiving terminal in a communication network, the system comprising:
a viseme detector operable to receive a voice component of an incoming communication stream from the sending terminal and generate first avatar control parameters therefrom;
a video tracker operable to receive a video component of the incoming communication stream and generate second avatar control parameters therefrom;
an avatar rendering engine, operable to render avatar images dependent upon at least one of the first avatar control parameters, second avatar control parameters and avatar control parameters in the incoming communication stream;
a video encoder, operable to encode the rendered avatar images to produce a synthetic video stream;
an adaptation decision unit, operable to receive inputs selected from the group of inputs consisting of:
the voice component of the incoming communication stream;
avatar control parameters in the incoming communication stream;
a natural video component of the incoming communication stream; and
the synthetic video stream; wherein the adaptation decision unit is operable to select at least one of the inputs as an output to be transmitted to the at least one receiving terminal.

16. A system in accordance with claim 15, wherein the adaptation decision unit is operable to select the output dependent upon a preference of a user of the at least one receiving terminal.

17. A system in accordance with claim 15, wherein the adaptation decision unit is operable to select the output dependent upon capabilities of the at least one receiving terminal.

18. A system in accordance with claim 15, wherein the adaptation decision unit is operable to select the output dependent upon a load status of the system.

19. A system in accordance with claim 15, wherein the adaptation decision unit is operable to select the output dependent upon the capacity of a communication channel between the receiving terminal and the system.

20. A system in accordance with claim 15, further comprising a behavior detector operable to receive the voice component of an incoming communication stream from the sending terminal and generate third avatar control parameters therefrom, wherein the avatar rendering engine is further operable to render avatar images dependent upon the third avatar control parameters.

21. A system in accordance with claim 15, further comprising a means for disabling at least one of the viseme detector, the video tracker, the avatar rendering engine, the video encoder, and the adaptation decision unit.
